(19) United States
(12) Patent Application Publication
(10) Pub. No.: US 2008/0021153 A1
(43) Pub. Date: Jan. 24, 2008

(54) Thin-wall waterborne soft-feel paint

(76) Inventors: Ho Tak Jeon, Hwaseong-si (KR); Soon Joon Jung, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/595,403

(22) Filed: Nov. 8, 2006

(30) Foreign Application Priority Data
Jul. 5, 2006 (KR) 10-2006-0063164

(51) Int. Cl. C08G 18/08

(52) U.S. Cl. 524/589

(57) ABSTRACT

The present invention provides a thin-wall waterborne soft-feel paint. In particular, the thin-wall waterborne soft-feel paint with a reduced coating thickness of about 20 to about 25 microns. The present invention offers the advantage of cost saving and the improvement in the odor due to the reduced amount of paint, as well as the improvement in the embossment on the product surface.

### CROSS-REFERENCE TO RELATED APPLICATIONS

This application claims priority to Korean Patent Application No. 10-2006-0063164, filed Jul. 5, 2006 the disclosure of which is incorporated herein by reference.

### BACKGROUND OF THE INVENTION

a) Field of the Invention

The present invention relates to a thin-wall waterborne soft-feel paint.

b) Description of the Related Art

Currently, a variety of cutting-edge products are being released in the auto market which are pleasing consumer's taste. Likewise, as high-quality automobile interior goods are gaining focus, the world's leading automakers are actively investing in the development of high-quality automobile interior. Enhancements to the interior of the automobile include real wood coating, metalizing technique, and waterborne soft-feel paint, etc. In addition to these improvements, the direction of the development is heading toward using environment-friendly materials and techniques.

Soft-feel paint is an advanced functional paint which is one step ahead of ordinary paints and is used to protect the exterior of the parts or products. Soft-feel paint can come in various colors and decorations. The soft-feel paint is used to add a soft feel to automobile interior goods which are frequently contacted by drivers and passengers. The soft feel is typically provided by a polyurethane resin which is synthesized from isocyanate and polyol. A variety of soft feel can be attained by varying contents and molecular weights. The first soft-feel paint developed in 2000 was an oil-based one in which a resin is dispersed in a solvent. Due to odor and environmental problems of oil-based soft feel paint, waterborne soft-feel paints are currently being used.

A waterborne soft-feel paint is a paint in which a resin is dispersed in water. It is currently being used in most of the expensive automobiles. Even in inexpensive cars, it is frequently used to offer a unique concept. The major parts where the waterborne soft-feel paint is used include the instrument panel, door trim, console cover, center fascia panel, etc.

### SUMMARY OF THE INVENTION

The present invention provides a thin-wall waterborne soft-feel paint offering with a coating thickness of about 20 to about 25 microns, comprising: (a) about 15 to about 20 wt % of polyester polyol, (b) about 5 to about 10 wt % of polycarbonate polyol, (c) about 5 to about 12 wt % of a yellowing-resistant isocyanate resin as curing agent, (d) about 0.3 to about 2 wt % of a hydrophilic resin, (e) about 35 to about 55 wt % of deionized water, (f) about 2 to about 5 wt % of a pigment used as an additive, (g) about 0.5 to about 2 wt % of a light stabilizer, (h) about 0.3 to about 2 wt % of a thickener, (i) about 3 to about 7 wt % of a matting agent, and (j) about 2 to about 5 wt % of an aliphatic organic solvent.

In one embodiment, the yellowing-resistant isocyanate resin is selected from the group consisting of isophrone diisocyanate and hydrophilic hexamethylene diisocyanate. In another embodiment, the hydrophilic resin comprises is selected from the group consisting selected of dimethylolpropionic acid and dimethylolbutanoic acid. In another embodiment, the pigment is selected from group consisting of TiO₂, carbon black, a yellow pigment, a blue pigment, a green pigment and a red pigment. In another embodiment, the light stabilizer is selected from the group consisting of a UV absorber and a UV HALS. In another embodiment, the thickener is selected from the group consisting of an acrylic thickener and a urethane thickener. In another embodiment, the matting agent is selected from the group consisting of silica, an aliphatic hydrocarbon wax and a silica wax. In another embodiment, the aliphatic organic solvent is selected from the group consisting of an acetate compound and an alkylene glycol methyl ether.

### DETAILED DESCRIPTION OF THE INVENTION

The present invention relates to a thin-wall waterborne soft-feel paint with a reduced coating thickness of about 20 to about 25 microns as compared with the conventional waterborne soft-feel paint (about 35 to about 40 microns), while maintaining other coating properties (abrasion resistance, adhesiveness, etc.) and soft feel.

Preferably, the thin-wall waterborne soft-feel paint, in accordance with the present invention, comprises about 15 to about 20 wt % of polyester polyol, about 5 to about 10 wt % of polycarbonate polyol, about 5 to about 12 wt % of a yellowing-resistant isocyanate resin as a curing agent, about 0.3 to about 2 wt % of a hydrophilic resin, about 35 to about 55 wt % of deionized water, about 2 to about 5 wt % of a pigment as an additive, about 0.5 to about 2 wt % of a light stabilizer, about 0.3 to about 2 wt % of a thickener, about 3 to about 7 wt % of a matting agent and about 2 to about 5 wt % of an aliphatic organic solvent and has a solid content of about 50 to about 60 wt %.

In the present invention, polyester polyol and polycarbonate polyol, are used in admixture. Preferably, the polyester polyol and the polycarbonate polyol have a molecular weight of about 8,000 to about 15,000 daltons. If the molecular weight is smaller than about 8,000 daltons, it may be difficult to attain a soft feel. In contrast, if the molecular weight is larger than about 15,000 daltons, the coating properties (adhesiveness, abrasion resistance, scratch resistance, etc.) tend to deteriorate. If the content of the polyester polyol is smaller than about 15 wt %, the degree of cure decreases. In contrast, if the content of the polyester polyol is larger than about 20 wt %, storage property and adhesiveness tend to deteriorate. If the content of the polycarbonate polyol is smaller than about 5 wt %, coating properties such as adhesiveness and abrasion resistance tend to deteriorate. In contrast, if the content of the polycarbonate polyol is larger than about 10 wt %, it is difficult to attain a soft feel, and moreover, an offensive odor may be generated.

In a preferred embodiment, the yellowing-resistant isocyanate resin includes, but is not limited to, isophrone diisocyanate and hydrophilic hexamethylene diisocyanate. If the content of the yellowing-resistant isocyanate resin is smaller than about 5 wt %, yellowing may occur during curing. In contrast, if the yellowing-resistant isocyanate resin is larger than about 12 wt %, whitening may occur and the water resistance may decrease.

In a preferred embodiment, the hydrophilic resin, includes, but is limited to, dimethylolpropionic acid and dimethylolbutanoic acid. If the content of the hydrophilic resin is smaller than about 0.3 wt %, the storage property may deteriorate due to insufficient dispersion. In contrast, if the content of the hydrophilic resin is larger than about 2 wt %, the adhesiveness may decrease (during re-coating).

In a preferred embodiment, the deionized water includes, but is not limited to, the natural water in which cations such as sodium, calcium and anions such as chloride, sulfate are removed. If the content of deionized water is smaller than about 35 wt %, the content of the hydrophilic resin has to be increased to improve the dispersibility. In contrast, if the content of deionized water is larger than about 55 wt %, the solid content decreases.

In a preferred embodiment, the pigments includes, but is not limited to, TiO₂, carbon black, a yellow pigment, a blue pigment, a green pigment and a red pigment In an exemplary embodiment, pigments may be mixed together to produce the wanted color. If the content of the pigment is smaller than about 2 wt %, coloring and coverture are insufficient. In contrast, if the content of the pigment is larger than about 5 wt %, coating properties such as heat resistance and light resistance may deteriorate.

In a preferred embodiment, the light stabilizer includes, but is not limited to, a mixture of a UV absorber and a UV HALS. In a more preferred embodiment, the UV HALS and the UV absorber is mixed at a proportion of about 2 to 1 based on weight. If the content of the light stabilizer is smaller than about 0.5 wt %, yellowing may occur and polish declines. In contrast, if the content of the light stabilizer is larger than about 2 wt %, the coating surface may become unstable.

In a preferred embodiment, the thickener includes, but is not limited to, an acrylic thickener and a urethane thickener. If its content of the thickener is smaller than about 0.3 wt %, the paint may trickle down during coating. In contrast, if the thickener is larger than about 2 wt %, the deterioration of the pot life and the storage property may become a problem.

In a preferred embodiment, the matting agent includes, but is not limited to silica, an aliphatic hydrocarbon wax and a silica wax. In a more preferred embodiment, silica or a silica wax may be used. If the content of the matting agent is larger than about 7 wt %, the paint becomes vulnerable to scratching.

In a preferred embodiment, the aliphatic organic solvent includes, but is not limited to, an acetate compound and an alkylene glycol methyl ether. In a preferred embodiment, the aliphatic organic solvent has superior dispersion stability. In a more preferred embodiment, the aliphatic organic solvent includes, but is not limited to, ethyl acetate, propyl acetate, butyl acetate, ethylene glycol methyl ether, diethylene glycol methyl ether, butylene glycol methyl ether, dibutylene glycol methyl ester, propylene glycol methyl ether and dipropylene glycol methyl ether. If the content of the aliphatic organic solvent is smaller than about 2 wt %, the surface leveling worsens, while in contrast, if the content of the aliphatic organic solvent is larger than about 5 wt %, whitening may occur during curing.

The thin-wall waterborne soft-feel paint of the present invention may further comprise various additives, which includes, but is not limited to, wetting agent, and thixotropic agent. The content of such additives may be adjusted depending on the final use or the properties of the product or other factors.

### EXAMPLE 1 AND COMPARATIVE EXAMPLES 1-3

A waterborne primer was coated to a thickness of about 7-10 microns on polypropylene test samples (HT240, Hyundai Engineering Plastics) in order to improve the adhesiveness between the sample material and the paint. After drying at about 80° C. for about 10 minutes, the thin-wall waterborne soft-feel paints listed in Table 1 were coated to a thickness of about 20 to about 25 microns, then after being kept at the room temperature for 10 minutes, the samples were dried at about 80° C. for about 20 minutes for completion.

The test samples of Example 1 and Comparative Examples 1-3 were obtained by adjusting the weight proportion of a polyester polyol with a molecular weight of about 10,000 daltons and a polycarbonate polyol with a molecular weight of about 10,000 daltons.

A 2.5:1 (based on weight) mixture of carbon black and TiO₂ was used as the inorganic pigment. As for the light stabilizer, a 2:1 (based on weight) mixture of a UV HALS and a UV absorber was used. For the solvent, a 1:1 (based on weight) mixture of propylene glycol methyl ether and dipropylene glycol methyl ether was used.

TABLE 1

| | | | Comp. Ex. 1 | Comp. Ex. 2 | Ex. 1 | Comp. Ex. 3 |
|---|---|---|---|---|---|---|
| Resin | Polyester polyol [Bayhydur | | 25 | 22.5 | 17.5 | 12.5 |
| | PR-340, BAYER] | | | | | |
| | Polycarbonate polyol [PC | | 0 | 2.5 | 7.5 | 12.5 |
| | 51, Noveon] | | | | | |
| | Hydrophilic hexamethylene | | 10 | 10 | 10 | 10 |
| | diisocyanate [WF2102, | | | | | |
| | Rhodia] | | | | | |
| | Dimethylolpropionic acid | | 1 | 1 | 1 | 1 |
| | [Aldrich] | | | | | |
| Additives | Inorganic | TiO₂ [R-902, | 3 | 3 | 3 | 3 |
| | pigment | DuPont] | | | | |
| | | Carbon black | | | | |
| | | [MA-100, | | | | |
| | | Mitsubishi] | | | | |
| | Light | UV HALS | 0.5 | 0.5 | 0.5 | 0.5 |
| | stabilizer | [Tinuvin 292, | | | | |
| | | Ciba] | | | | |
| | | UV absorber | | | | |
| | | [Tinuvin 1130, | | | | |
| | | Ciba] | | | | |
| | Thickener | Urethane | 0.5 | 0.5 | 0.5 | 0.5 |
| | | thickener | | | | |
| | | [Rheolate 244, | | | | |
| | | Elimentis] | | | | |
| | Matting | Silica [Acematt | 6 | 6 | 6 | 6 |
| | agent | TS-100, | | | | |
| | | Degussa] | | | | |

| | | | | | |
|---|---|---|---|---|---|
| Solvent | Propylene glycol methyl | 4 | 4 | 4 | 4 |
| | ether [ARCOSOLV PM, | | | | |
| | LYONDELL] | | | | |
| | Dipropylene glycol methyl | | | | |
| | ether [ARCOSOLV DPM, | | | | |
| | LYONDELL] | | | | |
| Water | Deionized water | 50 | 50 | 50 | 50 |

| | | | | |
|---|---|---|---|---|
| Total | 100 | 100 | 100 | 100 |

### TEST EXAMPLE

### Physical Property Test (Adhesiveness at Room Temperature)

Each test sample was cross-cut at an interval of about 2 mm, with 11 horizontal and vertical cuts each. The surface of the sample was brushed cleanly and a tape with adequate width and length was firmly attached. Then, the tape was tightly pulled from one side at a 90° angle and the number of peeled squares was counted out of 100 squares in total. The number of peeled squares represents the status of adhesiveness and the more the number of peeled squares, the worse the adhesiveness is.

The adhesiveness at elevated temperature: The same test as above was performed after keeping the sample at about 110° C. for about 300 hours and then at the room temperature for about 1 hour.

The adhesiveness after exposure to light: The sample was exposed to xenon arc under the condition of: black panel temperature ˜89±3° C., humidity=50±5% RH, luminance=0.55±0.02 W/m² nm (at 340 nm). When the total amount of irradiation reached 1050 KJ/m², the test sample was cleansed with a neutral detergent solution and dried in air. After keeping at the room temperature for 1 hour, the above adhesiveness test was carried out.

The dry abrasion test: The test sample was scrubbed against cotton sailcloth to and from under the condition of: load=1 kgf, speed=30 cycles/min, frictional stroke 1100 mm. The number of exposure of original surface was counted.

Each test was carried out for 5 times and the test result was averaged. The result thereof is given in Table 2 below.

TABLE 2

| | | | Adhesiveness | |
|---|---|---|---|---|
| | Adhesiveness at | Adhesiveness at | after exposure to | Dry abrasion |
| | room temperature (# | elevated temperature | light (# of peeled | (# of exposure of |
| | of peeled squares) | (# of peeled squares) | squares) | original surface) |
| Comp. Ex. 1 | 3 | 75 | 100 | 150 |
| Comp. Ex. 2 | 0 | 1 | 7 | 800 |
| Ex. 1 | 0 | 0 | 0 | 2,400 |
| Comp. Ex. 3 | 0 | 0 | 0 | 2,700 |

As seen in Table 2 above, the overall coating properties including the adhesiveness at the room temperature, the adhesiveness at elevated temperature, the adhesiveness after exposure to light and the abrasion resistance were improved according to the increase in the content of polycarbonate polyol. As seen in Comparative Example 1 and Comparative Example 2, the adhesiveness and abrasion resistance were significantly improved even with a small content of polycarbonate polyol, while as seen in Example 1, a perfect coating adhesiveness could be attained with a polycarbonate polyol content of approximately 7.5%. Comparative Example 3 showed the best adhesiveness and abrasion resistance, but the coating was too hard to attain a soft feel. To conclude the above examples, a thin-wall waterborne soft-feel paint prepared with a polycarbonate content of about 7.5% (Example 1) were satisfactory in coating properties and soft feel.

The present invention provides a thin-wall waterborne soft-feel paint which has a reduced coating thickness of about 20 to about 25 microns.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and the scope of the present invention as set forth in the appended claims.

What is claimed is:

1. A thin-wall waterborne soft-feel paint offering with a coating thickness of about 20 to about 25 microns, comprising:
(a) about 15 to about 20 wt % of polyester polyol;
(b) about 5 to about 10 wt % of polycarbonate polyol;
(c) about 5 to about 12 wt % of a yellowing-resistant isocyanate resin as curing agent;
(d) about 0.3 to about 2 wt % of a hydrophilic resin;
(e) about 35 to about 55 wt % of deionized water;
(f) about 2 to about 5 wt % of a pigment used as an additive;
(g) about 0.5 to about 2 wt % of a light stabilizer;
(h) about 0.3 to about 2 wt % of a thickener;
(i) about 3 to about 7 wt % of a matting agent; and
(j) about 2 to about 5 wt % of an aliphatic organic solvent.

2. The soft-feel paint as set forth in claim 1, wherein the yellowing-resistant isocyanate resin is selected from the group consisting of isophrone diisocyanate and hydrophilic hexamethylene diisocyanate.

3. The soft-feel paint as set forth in claim 1, wherein the hydrophilic resin comprises is selected from the group consisting selected of dimethylolpropionic acid and dimethylolbutanoic acid.

4. The soft-feel paint as set forth in claim 1, wherein the pigment is selected from group consisting of TiO₂, carbon black, a yellow pigment, a blue pigment, a green pigment and a red pigment.

5. The soft-feel paint as set forth in claim 1, wherein the light stabilizer is selected from the group consisting of a UV absorber and a UV HALS.

6. The soft-feel paint as set forth in claim 1, wherein the thickener is selected from the group consisting of an acrylic thickener and a urethane thickener.

7. The soft-feel paint as set forth in claim 1, wherein the matting agent is selected from the group consisting of silica, an aliphatic hydrocarbon wax and a silica wax.

8. The soft-feel paint as set forth in claim 1, wherein the aliphatic organic solvent is selected from the group consisting of an acetate compound and an alkylene glycol methyl ether.
